(19) United States
(12) Patent Application Publication
(10) Pub. No.: US 2013/0132469 A1
(43) Pub. Date: May 23, 2013

(54) ELECTRONIC CONTENT DELIVERY USING DIVERSIFIED NETWORKS

(71) Applicant: Warner Bros. Entertainment, Inc., Burbank, CA (US)

(72) Inventors: Alan Levicki, Burbank, CA (US); Essam Mahmoud, Burbank, CA (US)

(73) Assignee: WARNER BROS. ENTERTAINMENT, INC., Burbank, CA (US)

(21) Appl. No.: 13/683,933

(22) Filed: Nov. 21, 2012

Related U.S. Application Data
(60) Provisional application No. 61/563,407, filed on Nov. 23, 2011.

(51) Int. Cl. H04L 29/06

(52) U.S. Cl. CPC H04L 65/4061
USPC 709/203

(57) ABSTRACT

Methods and apparatus for electronic content delivery of an electronic data file to be provided to a first client device may include a computer identifying two or more recipient client devices as members in a distribution group with the first client device. The computer may divide the electronic data file into two or more segments based on respective parameters for different transmission paths to the two or more recipient client devices. The computer transmits the two or more segments concurrently over the different transmission paths to the two or more recipient client devices. The computer may generate instructions for assembling the two or more segments to obtain the electronic data file, and transmit the instructions to at least one of the first client device or the two or more recipient client devices.

### CROSS-REFERENCE TO RELATED APPLICATION

This application claims priority pursuant to 35 U.S.C. §119(e) to U.S. provisional application Ser. No. 61/563,407, filed Nov. 23, 2011, which is hereby incorporated by reference, in its entirety.

### BACKGROUND

1. Field

This application relates to methods and apparatus for electronic content delivery, and more particularly to content delivery using diversified networks to deliver data files, for example, digital audio-video data files.

2. Description of Related Art

Digital audio-video content is increasingly delivered to consumers via a delivery channel known as digital download. Digital download refers to transmission of digital audio-video content, sometimes called digital content, from a source device to a designated client device via a communications or computer network, in response to a client request requesting the specific digital content that is delivered. Digital download may be typically provided over broadband wide-area networks (WANs), for example, the Internet. Digital content may be stored as one or more files in a memory for the destination device. Access to the digital content may be limited to one or more destination devices or to one or more specific user accounts. Access to digital content may be restricted to a specific time window, or may be unrestricted using digital rights management (DRM). The client receiving a digital download is typically equipped with a processor, user interface, and memory. For example, a client may comprise a computer, smart phone, game console, or notepad device. Digital content may include, for example, motion pictures, documentaries, episodes of serial programming, or special features.

Digital download may be contrasted with distribution via a broadcast channel, as used in television broadcasting via cable, wireless, or satellite networks. Broadcast channels, even digital channels, provide a predetermined stream of audio-video data to a set-top box, video recorder, television, game console, or other client, typically over a dedicated transmission channel. The stream may be recorded if the client is equipped with memory, but is not provided in response to a specific request for specific digital content. The client device may select different channels for viewing, but not specific content files within a channel.

Broadcast channels as used to deliver content over dedicated transmission channels should not be confused with the term “channel” as sometimes used in digital downloading over computer networks. In the context of a digital download, a “channel” may refer to bundling multiple files together as a subscription service, and optionally releasing different files for download at different times. Thus, a user may subscribe to a channel that provides access to a specific type of content for digital download, for example, a comedy, sports, or travel digital download channel. However, unlike broadcast channels, a digital download channel permits users to select specific content within the channel's offerings for digital download to a specified client device, at a time of the user's choosing.

Digital download systems thereby permit users to download copies of digital audio-video content to a designated client device. In some circumstances, for example with copyrighted content provided under a license in exchange for payment or the like, the digital download is conditioned on the client device being associated with an identifier for a user account. Notwithstanding the advantages of current digital download systems, downloading of digital audio-video content or other electronic data files over a broadband WAN may still take a relatively long time; for example greater than an hour, or even several hours. Such delays may cause difficulties for persons downloading electronic data files and requires advance planning. In addition, some download attempts may not be successfully completed, and failures that occur after a long period of time downloading a file may waste a correspondingly large amount of time. It would be desirable to provide a quicker, more robust way to download digital audio-video content or other electronic data files to various client devices.

As used herein, “digital audio-video content” or “digital content” refers to audio-video content encoded as a digital file or files. Audio-video content is characterized by a sequence of video frames coupled to an audio track, for playing in sequence by a media player application on the client device. In addition, as used herein, a “file” or “digital file” refers to a set of electronic digital data that is encoded in a computer-readable storage medium (e.g., a non-transitory medium) and referenced by a file name or similar identifier in a directory or similar data structure for the storage medium. As such, a file is clearly distinguished from a packet or other transitory data set transmitted via a carrier wave. Information contained in a file and file metadata may be transmitted using a carrier wave, for replicating the file in a different storage medium. Such transmission and replication may sometimes be referred to as “transmitting a file,” but this and similar terminology does not negate the essential character of a file being a discrete data set encoded in a non-transitory medium, for example in a storage medium.

### SUMMARY

Methods, apparatus and systems for electronic content delivery are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In some embodiments performed by computer servers, a method for electronic content delivery may include receiving, at a computer, a request for an electronic data file to be provided to a first client device, identifying two or more recipient client devices as members in a distribution group with the first client device, dividing the electronic data file into two or more segments based on respective parameters for different transmission paths to the two or more recipient client devices, and transmitting the two or more segments concurrently over the different transmission paths to the two or more recipient client devices. The method may further include generating instructions for assembling the two or more segments to obtain the electronic data file, and transmitting the instructions to at least one of the first client device or the two or more recipient client devices.

In another aspect, the method may include determining a current status of members of the distribution group, in response to receiving the request for the electronic data file. In such case, identifying the two or more recipient client devices may include selecting the two or more recipient devices based on the current status. In addition, selecting the two or more recipient devices may be based on the respective parameters of the different transmissions paths. For example, the respective parameters on which the selecting is based may be include a maximum data rate, a bandwidth, and a signal quality. As used herein, a specified result “based on” certain input means that the results depends on or is a function of the certain input. The different transmission paths may include different communication networks. The method may further include determining the distribution group by membership in a Local Area Network.

In another aspect, the method may include receiving confirmation messages from each of the two or more recipient devices, confirming that each segment has been received.

In another aspect, identifying the two or more recipient client devices may include selecting the two or more recipient client devices to include the first client device. In the alternative, identifying the two or more recipient client devices may include selecting the two or more recipient client devices to exclude the first client device. Thus, for example, a user may use the first client device (e.g., mobile phone) to select different clients, for example other computing devices in the home, for receiving a transmission.

In other embodiments performed by client devices, a method for electronic content distribution may include generating, at a first client device, a request for an electronic data file, transmitting the request to a content server, receiving a message from the content server describing instructions for receiving the electronic data file concurrently in two or more segments over different transmission paths for delivery to two or more recipient client devices belonging to a distribution group with the first client device, and receiving the electronic data file according to the instructions. The method may further include assembling the two or more segments to obtain the electronic data file. The method may further include identifying one or more members of the distribution group to the content server. For example, the client may identify a network address for a Local Area Network to which the two or more recipient client devices are connected.

The method by a client device may further include receiving at least one of the two or more segments via one of the different transmission paths, and providing the at least one of the two or more segments to a designated node in the distribution group. In an aspect, receiving the electronic data file may include receiving the electronic data file from the designated node. For example, the client device may receive the electronic data file via a Local Area Network.

In another aspect, the client method may include providing a parameter of one of the different transmissions paths to the content server, in response to a status inquiry.

For example, the parameter may be selected from a maximum data rate, a bandwidth, and a signal quality. In some embodiments, the first client device does not receive any of the two or more segments until said segments are assembled into the electronic data file.

In other embodiments performed by ancillary clients supporting delivery of an electronic file, a method may include receiving instructions from a content server for receiving an electronic data file requested by an identified first client device concurrently in two or more segments over different transmission paths for delivery to two or more identified recipient client devices belonging to a distribution group with the first client device, obtaining the two or more segments after said two or more segments are received by the two or more recipient devices, and assembling the two or more segments to obtain the electronic data file according to the instructions. The method may further include transmitting the electronic data file to the first client device, for example, over a Local Area Network.

In an aspect, the method may include receiving at least one of the two or more segments; for example, receiving the at least one of the two or more segments from the content server or from at least one of the two or more recipient client devices. In addition, the method may include providing the at least one of the two or more segments to the first client before assembling the two or more segments. The method may further include storing the electronic data file for later distribution to a member of the distribution group.

In related aspects, a computer system may be provided for performing any of the methods and aspects of the methods summarized above. A system may include, for example, a computer server or client device including a processor and a memory, and a port for connecting to a communication network, wherein the memory holds instructions for execution by the processor to cause the apparatus to perform operations as described above. An article of manufacture may be provided, including a non-transitory computer-readable medium holding encoded instructions, which when executed by a processor, may cause an apparatus to perform the methods and aspects of the methods as summarized above.

Further embodiments, aspects and details of methods, apparatus and systems for electronic content delivery are presented in the detailed description that follows.

### BRIEF DESCRIPTION OF THE DRAWINGS

The present invention, in accordance with one or more various embodiments, is described in detail with reference to the following figures.

FIG. 1 is a block diagram showing an example of a system for content delivery using diversified networks to deliver data files.

FIG. 2 is a flow chart illustrating an example of a method for content delivery using diversified networks to deliver data files, for performance by a content distribution node.

FIG. 3 is a flow chart illustrating an example of a method for content delivery using diversified networks to deliver data files, for performance by a requesting content destination node.

FIG. 4 is a flow chart illustrating an example of a method for content delivery using diversified networks to deliver data files, for performance by a non-requesting content destination node.

FIG. 5 is a flow chart illustrating an example of a method for content delivery using diversified networks to deliver data files, for performance by a non-requesting, non-destination node.

FIG. 6 is a sequence diagram illustrating an example of data flows and operations involving different nodes and networks, for content delivery using diversified networks to deliver data files.

FIG. 7 is a screen shot showing an example of a data table or “dashboard” that a member of a subscriber group may use to access or organize content that is deemed accessible within the group.

FIG. 8 is a flow chart illustrating another example of a method for content delivery using diversified networks to deliver data files, for performance by a content distribution node.

FIG. 9 is a block diagram showing illustrative components of an apparatus for performing a method as shown in FIG. 8.

FIG. 10 is a flow chart illustrating another example of a method for content delivery using diversified networks to deliver data files, for performance by a requesting content destination node.

FIG. 11 is a block diagram showing illustrative components of an apparatus for performing a method as shown in FIG. 10.

FIG. 12 is a flow chart illustrating another example of a method for content delivery using diversified networks to deliver data files, for performance by a non-requesting content destination node.

FIG. 13 is a block diagram showing illustrative components of an apparatus for performing a method as shown in FIG. 12.

### DETAILED DESCRIPTION

The present disclosure describes a technology enabling content delivery using diversified networks to deliver data files, for example, digital audio-video data files more quickly and more robustly than prior approaches. The present technology uses a group of two or more client devices to cooperatively and concurrently download different portions (“segments”) of an electronic data file from a content server. Each segment may be sized and configured to require approximately the same amount of time to download. Each segment may be transmitted from the content server to a different destination client via different transmission paths, for example, via different communications networks. The client devices may provide received segments to a designated node, which may assemble the segments to obtain the requested electronic data file, and provide the data file to a designated destination device. The present technology may therefore make use of the fact that a household or person may have access to two or more independent communications paths to the content server, using two or more client devices. For example, a user may have access to a personal computer connected to a router and modem to a WAN, and a smart phone connected to the WAN via a macrocell or femtocell of a wireless communications network.

In an aspect, a user may leverage all connected devices in a household to collaborate on downloading electronic files, for example, movies, TV shows, games, and other electronic content. For example, many households may have access to multiple client devices, for example, a first member of the household may have a “4G” Android™ phone, another may have a “3G” iPhone™, and the household may share a Wi-Fi Internet connection via a DSL modem or cable modem via a personal computer or game console. In an aspect, the technology enables such multiple devices to work together to download chunks of the movie in approximately 1/N of the time that it will take a regular download to happen, where “N” is the number of separate transmission paths available. In another aspect, a user may set up a personal computer or iMac™ as a Wi-Fi server to multicast downloaded movies to multiple devices concurrently.

In another aspect, content may be downloaded from a cloud server, such as Ultraviolet™. In an aspect, a serving node may divide the content up into chunks (“segments”), for example using hashes as done in BitTorrent™ or similar applications. Multiple devices within, for example, a trusted network of devices (e.g., a family's home PC, parents' and children's smart phones, 3G iPad™, and similar devices) simultaneously or concurrently download different portions of the content. The trusted devices themselves may be all resident on a wireless network, and once they finish receiving a discrete chunk of the content, may begin multicasting it to one or more other trusted devices on the trusted network. So at the same time, for example, a 4G phone in the group is downloading a chunk of a movie, it may be wirelessly transferring a different chunk of the same movie it has already downloaded to other devices on a wireless (or wired) LAN; it may also be wirelessly receiving other chunks of the movie that have finished downloading on other devices in the trusted group. This approach may take advantage of the fact that wireless transfer speeds within a LAN may be relatively fast—as fast as 100 MB/s, and thus, transfers of content to devices within the network may require much less time than downloading the content from a remote source.

In another aspect, a user may start downloading content using a mobile terminal (such as a smart phone or notepad computer) while being unconnected to a home LAN. The act of initiating the download may trigger a response from the cloud server whereby automatic downloading is initiated on one or more devices connected to the home LAN as well. Once the mobile device that initiated the download wirelessly syncs up with the other devices on the network (e.g., when the user carries his smart phone home) the portions of the movie that have not finished downloading on your phone may be pushed wirelessly to the recently arrived device over the LAN by a coordinating node connected to the LAN, for example a designated PC connected to the LAN.

The technology disclosed herein may be implemented as encoded instructions on a non-transitory computer-readable medium, which, when executed by one or more processors of a computer, cause the computer to perform the novel operation as described above to achieve results as described herein. The non-transitory computer-readable medium may be, or may include, a storage medium or memory medium. The technology may be implemented in an apparatus, for example a computer server, having a processor and memory, wherein the memory holds code for causing the server to perform the novel method to achieve results as described herein. The present disclosure therefore discloses illustrative steps of a method as exemplifying the novel technology, which is not limited to a method and may be implemented in various other ways such as described herein.

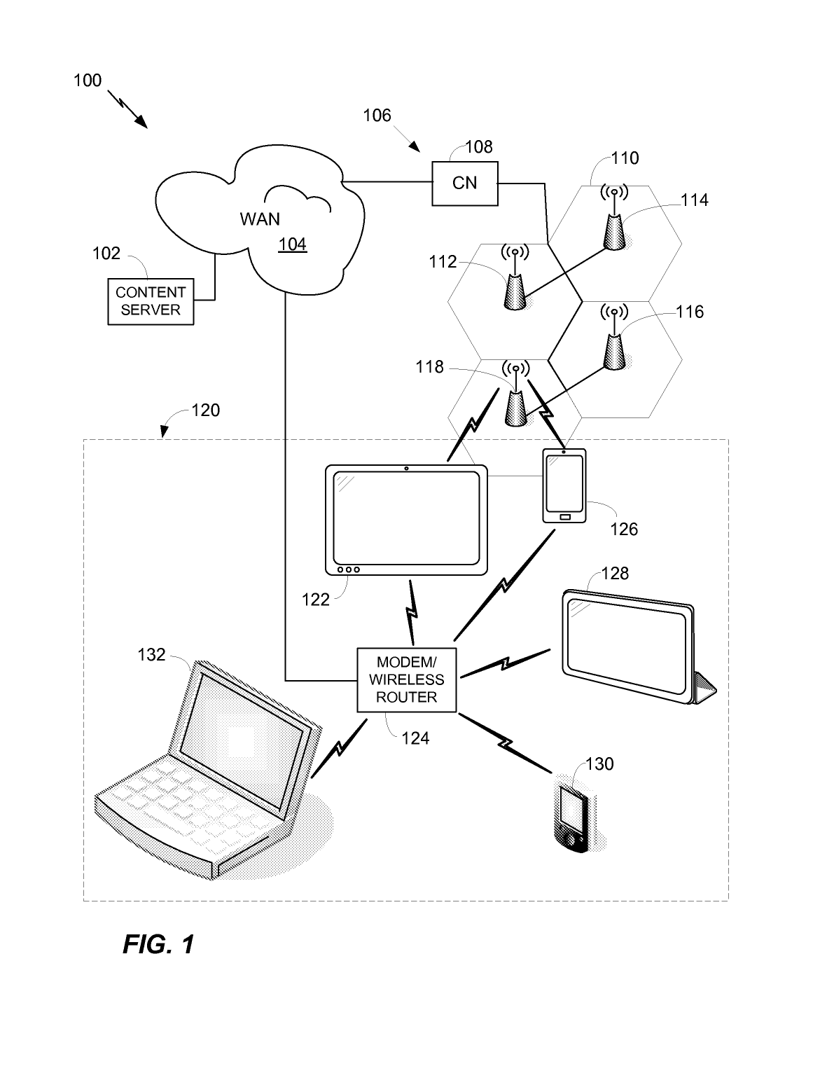

An example of a system 100 including aspects of content delivery using diversified networks to deliver data files is shown in FIG. 1. The system may comprise a content server 102 connected to a WAN 104. The content server 102 may comprise a single computer or group of computers that is addressable using a designated network address, and may include, for example, a cloud infrastructure as service, cloud platform as service, and/or cloud software of service, one or more of which may be generally referred to herein as a “cloud server.” The WAN 104 may also be communicatively coupled to one or more wireless communications networks (WCNs), for example, to a WCN 106. It is not unusual, however, for multiple WCNs to be available in any given area. The WCN may include, for example, core network components 108 and a cellular network 110 that include multiple interconnected wireless transmitting/receiving stations, for example, base stations 112, 114, 118, and 118. Higher power base stations for serving large public spaces may sometimes be called “macro” base stations. Lower power base stations designed for deployed in smaller enclosed spaces such as homes, offices, or interior public spaces may sometimes be called “femto” or “pico” base stations. Each WCN may be used to provide one or more separate transmission paths to a client device.

As exemplified in FIG. 1, different transmission paths may include, for example, a WAN 102 wired to a router 124 connecting to a Local Area Network (LAN) in a user's home or business; a WCN 106, for example a network using wireless technology such as defined by the 3^{rd} Generation Partnership Project (3GPP) General Packet Radio Service (GPRS), 3GPP2 Code Division Multiple Access 2000 (CDMA200), sometimes abbreviated as “3G,” 3GPP Long Term Evolution (LTE), sometime called “4G” or other wireless standards, using a macro base station, femto base station or pico base station. In addition, different operators using the same wireless technology on different frequency spectrum or providing different wired access via separate subscriber lines to a location (e.g., via separate dial-up, DSL, fiber-optic or cable modems) may constitute separate transmission pathways. Transmission pathways may be regarded as separate if available bandwidth or data capacity on each path is independent of the other so that, for example, use of one path to transmit data does not materially reduce available bandwidth on the other path.

The content server 102 may thus communicate with multiple devices in a subscriber group 120 or any other defined group of devices using at least two separate transmission pathways. For example, a subscriber group identified with a household location may include a personal computer 132, set-top box (not shown), game console (e.g., Xbox™, Playstation™, or Wii™, not shown), a tablet device 130 (e.g., Apple™ iPod™ device), a first notepad computer 122 running an Android™, Windows™ or other operating system, a smart phone 126, and an Apple™ iPad™ notepad computer 128. Each of these client devices 122, 126, 128, 130 and 132 may be capable of communicating with each other and with the WAN 104 using a router/modem device 124 and a wired (e.g., TCP/IP) or wireless (e.g., IEEE 802.11) connection to the router/modem 124. In addition, one or more of the devices 122, 126, 128, 130 and 132 may be capable of communicating with another device and with the WAN 104 via one or more WCNs. For example, the Android™ notepad computer 122 may communicate with the WAN 104 via the base station 118 and other components of the WCN 106, while the smart phone 128 may communicate via the same base station 118 or a different base station (e.g., the adjacent base station 116) of the WCN.

Each client device in the group 120, for example, the personal computer 132, notepad computer 122, 128, tablet computer 130, smart phone 126, or other client device, may be configured for accessing digital content using a display device to view video output from the client, in response to input from an input device. The input device may comprise a keyboard, touchscreen, microphone, or other transducer for converting physical input from a user into electrical signals for the client. Each client, for example, clients 122, 126, 128, 130 and 132, may comprise a processor, memory, network interface, and computer graphics display driver for providing video output to the display device, comprising an LCD display screen or similar device. Files containing protected audio-video content and metadata may be encoded on a computer-readable storage medium coupled to each client, for example, clients 122, 126, 128, 130 and 132, such as, for example, a magnetic, optical, or electronic data storage device. Each client, for example, clients 122, 126, 128, 130 and 132 may be configured to decode and decompress encoded content, and decrypt protected content, to provide a video signal for its respective display. The computer-readable medium in each client may further hold encoded instructions for performing certain actions as described herein, and downloaded digital video content files or other electronic content belonging to a digital content library for a user.

Each client, for example, clients 122, 126, 128, 130 and 132, may further comprise a network interface for communicating via the WAN 104, for example, the Internet. Via such an interface and network, each client device may communicate with the content server 102 operating a digital content distribution application responsive to input from multiple clients, such as clients 122, 126, 128, 130 and 132. The content server 102 may be coupled to a computer-readable storage medium, such as, for example, a magnetic, optical, or electronic data storage device. The computer-readable medium may hold encoded instructions for performing certain actions as described herein, and copies of digital content or other electronic content belonging to content libraries defined for one or more users. The content server 102 may enable distribution of content to multiple clients for validated system users via digital download of content files using one or more methods as described herein.

A content file for digital download by the content server 102 may include a protected component and an associated data component. The protected component may include content such as video data, audio data, image data, text data, or other content that is protected from access by unauthorized users or devices. For example, the protected content may be encrypted, and not accessible without a secure decryption key. In the alternative, or in addition, the content may be protected using an alternative protection scheme.

The associated or metadata component may contain unprotected data related to or about content in the protected component, and that is accessible without restriction. The unprotected data may include, for example, a file name, a purported title or description for the protected content, an identifier for one or more keys needed to access the protected content, a file size and/or file date, and encoding information concerning video frames and bit rates used to encode audio or video data included in the protected content. The unprotected data may include other metadata which may vary depending on file source. Characteristically for many data files, both the protected content and the metadata are static after file creation, meaning content and metadata do not change.

The content server 102 may maintain data for readily identifying devices identified as belonging to a particular subscriber group 120 or other group of destination client devices that are to participate in a particular download transaction. For example, the content server 102 or a separate authorization server may maintain platform type data and other data identifying mobile and other client devices registered for a user account, for example, telephone numbers and network addresses, in a registry or other data structure for each user account. In addition to user-maintained subscriber groups, the mobile content may in some cases enable distributed download within a temporary group of client devices set up for a particular time period or transaction. For example, a group of friends or business colleagues sharing a local Wi-Fi connection and using different mobile phone providers may want to set up a temporary group for distributed download using multiple connections available to the group. In this way, members of the group may receive downloaded content much more quickly than any individual user could. Accounting for such downloads (e.g., receiving payment for use of copyrighted content) may be handled on an individual or group basis, regardless of the mode of downloading used for a client device to acquire the content being charged for. In addition, in embodiments where the mobile content server 102 maintains copies of content for streaming to mobile devices, it may use platform information to respond appropriately to content requests, by providing content in a compatible data format to authorized mobile or other clients, while refusing requests from unauthorized clients.

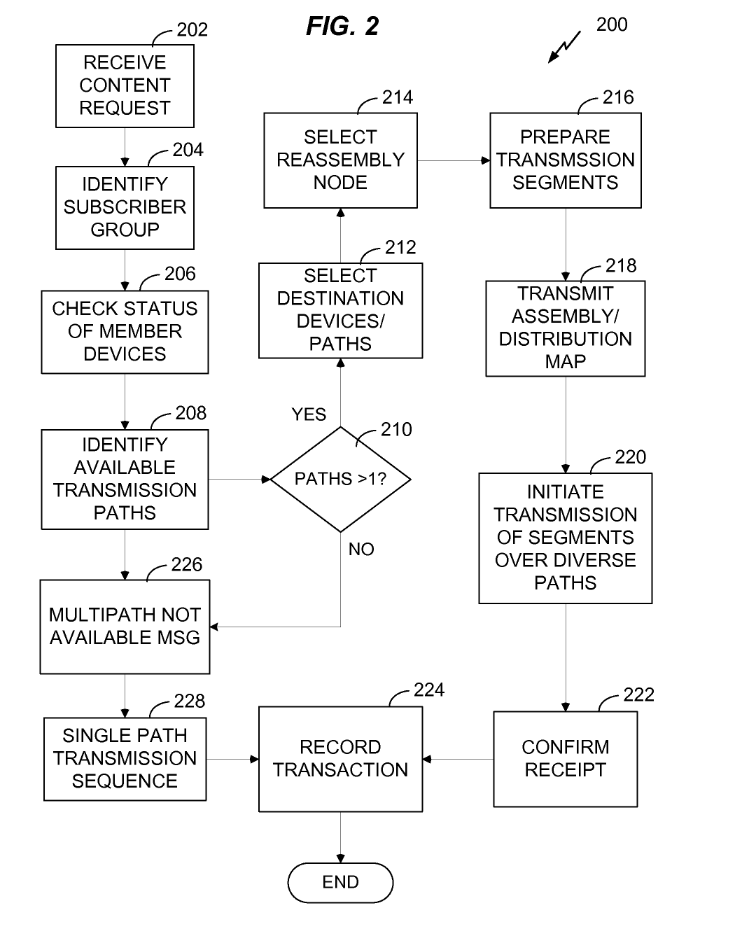

Referring to FIG. 2, a method 200 for content delivery using diversified networks to deliver data files, for performance by a content distribution node (CDN) such as a content server or cloud server, may include some or all of the illustrated actions. The method 200 may be initiated when, at 202, the CDN receives a message from a remote client requesting a specific content file or set of files. At 204, the CDN may identify a subscriber group or other group of client devices to which the requesting client devices belongs. For example, the CDN may extract a device identifier, user account identifier, and/or client device group identifier from the content request message, and query an internal or external database module with the one or more identifiers. In return, the database module may provide identifiers and network addresses for client devices in the subscriber group to the CDN, and optionally platform information for each device. The group data may be maintained by the database module using a subscriber interface, which may allow authorized users to set up permanent or temporary groups of client devices. Such groups may consist only of devices belonging to a single subscriber account. In the alternative, devices in the group may be registered to different subscriber accounts.

At 206, the CDN may determine (check) a current status of each user device identified in the group. For example, the CDN may transmit an inquiry to each device in the group, requesting a current status. The CDN may determine whether or not each device is connected via one or more networks and whether it is available to participate in a collaborative downloading process. At 208, the CDN may similarly determine which transmission paths (e.g., networks) are available for sending download data to each available client device in the group. Transmission path parameters may be recovered by the CDN from a device database, in a manner similar to other data for devices belonging to the group. In the alternative, or in addition, the CDN may transmit a message to each client device requesting that it report its available connection paths and one or more estimated parameters (e.g., bandwidth, data rate, or signal quality) for each transmission path.

If, as determined at 210, the number of available transmission paths is one, the CDN may transmit a message at 226 informing the requesting client device that collaborative multipath download is not currently available. The CDN may then, at 228, initiate a convention single path download process. In the alternative, in response to user input, the CDN may cancel or postpone the download process for a later time.

If, as determined at 210. the number of available transmission paths for downloading the requested content to the device is greater than one, then at 212, the CDN may select the most optimal set of available devices and transmission paths. For example, the CDN may select a default device, or a currently optimal device, for each transmission path, while utilizing a default or optimal device for each available smart phone. For example, if a device group includes two smart phone using the same wireless carrier, and one smart phone has a receiver system that is superior to the other smart phone (able to receive at a faster data rate), the CDN may select the smart phone with the superior receiver to be the designated receiver for content over that wireless carrier.

At 214, the CDN may select a reassembly node. The reassembly node is the node designated to receive all of the content segments, to assemble them into an assembled file, and push the assembled file to client devices in the group desiring to receive the requested content. In an embodiment, the reassembly node may be the requesting client. In the alternative, or in addition, the reassembly node may be a high-resource node such as a personal computer connected to a wireless LAN. The CDN may select more than one reassembly node; for example, the requesting client may assemble content segments for its own use, while a second default node assembles the content segments for other uses.

At 216, the CDN may prepare the transmission segments. This may include, for example, dividing the content into segments of appropriate size for each transmission segment. For example, if Qᵢ is the estimated data rate for each i^{th} transmission path for n paths, a appropriate segment size Sᵢ for that path may be determined by, for example, by:

$${S}_{i} = {Q}_{i} \frac{1}{{\sum }_{n}^{i = 1} {Q}_{i}} . \qquad Eq . 1$$

The CDN may perform other operations to prepare each segment, for example setting metadata for each segment to enable assembly of the segments into an assembled and operational content file, encryption, or encoding. Providing assembly instructions may include, at 218, providing assembly and/or distribution instructions in the segment metadata. In the alternative, or in addition, such instructions may be provided in one or more separate messages transmitted to the reassembly node or to any client receiving one of the content segments.

At 220, the CDN may initiate concurrent transmission of the segments over the diverse transmission paths. For example, the CDN may transmit a first segment via a WAN to a modem/router for a LAN identified with the receiving group of devices, and a second segment via a WAN to a wireless communications network addressed to a telephone number for a network subscriber. The transmissions may be performed concurrently using different network ports. At 222, the CDN may receive a confirmation that each segment has been received free of errors at the selected client devices. If errors are detected in a segment, the CDN may retransmit additional data for error recovery as known in the art. At 222, the CDN may record a completed download of the content file in its record for accounting or other users.

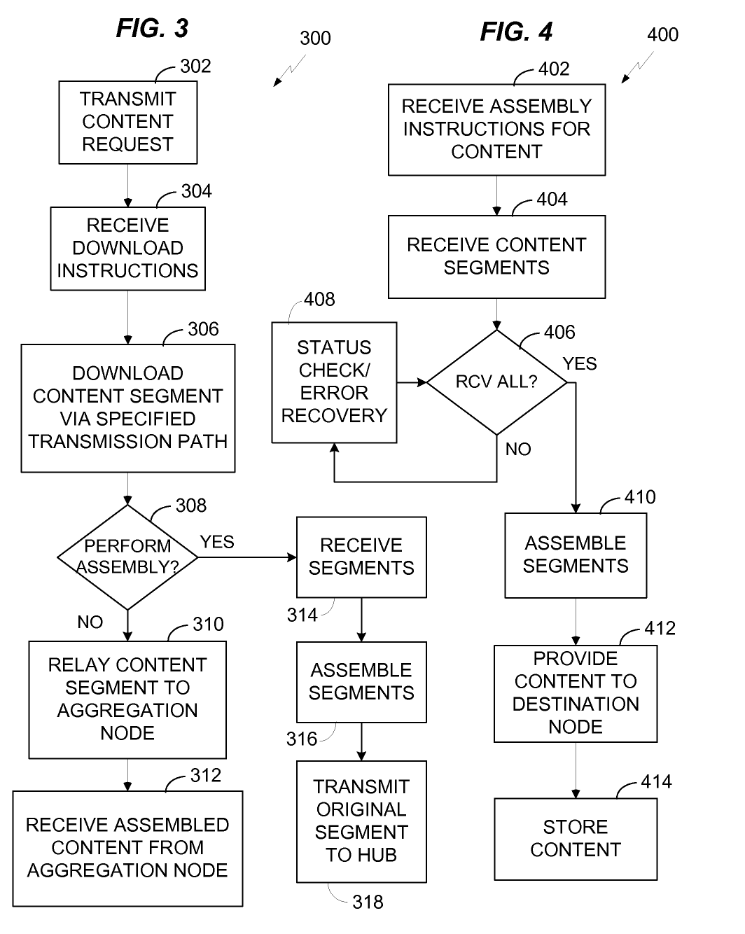

Referring to FIG. 3, an example of a method 300 for content delivery using diversified networks to deliver data files may be performed by a content destination node requesting the content. At 302, in response to user input such as browsing a content selection screen, a client device may transmit a signal to the CDN requesting particular content. At 304, the client device may receive download instructions. These instruction may be received by an application running in the background, and the application may, or may not, display information about the mode in which the download will be performed. So long as the users have identified the client devices in the participating group, the download process may proceed automatically without user involvement. However, the application may display progress of the downloading process at intervals, using progress bars for each participating device or other display tools.

At 306, the requesting client may receive one of the content segments via the specified transmission path; e.g., WAN or WCN as discussed above. At 308, if the receiving client is to perform an assembly task, it may at 314 receive one or more additional segments from participating clients in its group. At 316, the receiving client may assemble the segments into an assembled file, which it may use in the intended manner. At 318, the receiving client may transmit the original segment; i.e., the segment that it itself downloaded from the CDN, to another assembly node of the client group, if applicable. If at 308 the client is not to perform the assembly task, the client may relate the downloaded content segment to a designated aggregation (i.e., assembly) node. The receiving client may then, at 312, receive the assembled content back from the aggregation node for use as desired.

Referring to FIG. 4, a method 400 for content delivery using diversified networks to deliver data files may be performed by a non-requesting content destination node. The non-requesting node may be an assembly/aggregation node. At 402, the non-requesting node may receive a message from the CDN that it is being asked to participate in a collaborative downloading process. This message may be received by a client application or module, which may operate automatically as a background application requiring little or no user input to successfully complete. Optionally, the application may provide a status message or display showing current progress of a segment downloading or assembly operation. The message may identify the segments to be received by participating clients, how the segments are to be assembled and metadata for the content to be assembled. At 404, the assembling client may receive two or more segments required to assemble the requested content file. Optionally, the non-requesting client may receive a segment directly from the CDN via a selected one of the diverse transmission paths. The non-requesting client receives at least one of the segments from another participating client, typically via a LAN or WLAN connection. At 406, the non-requesting client may determine whether or not it has received all required segments. If one or more segments are missing, the non-requesting client may perform a status check and error recovery procedure at 408 until all segments are obtained. At 410, the client may assemble the segments. At 412, the client may provide the assembled content to a designated destination node or nodes. At 414, the client may store the assembled content in a library-type data structure for future use by devices belonging to the group, or other authorized uses.

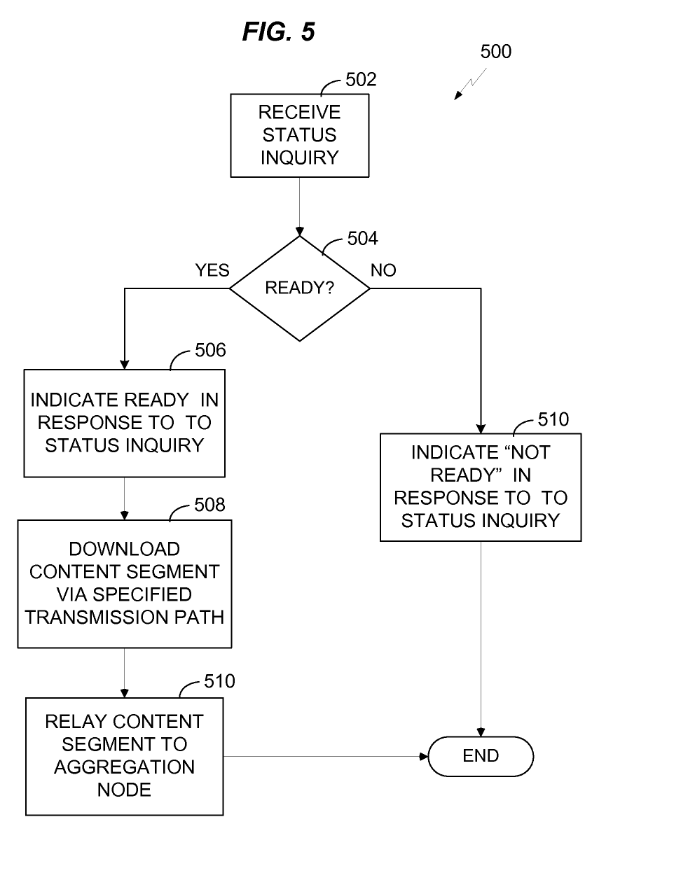

Referring to FIG. 5, a method 500 for content delivery using diversified networks to deliver data files may be performed by a non-requesting, non-destination node. At 502, the non-requesting node may receive a message from the CDN that it is being asked to participate in a collaborative downloading process and requesting a current status. This message may be received by a client application or module, which may operate automatically as a background application requiring little or no user input to successfully complete. Optionally, the application may provide a status message or display showing current progress of a segment downloading operation. If, at 504, the non-destination client is not ready to participate, it may indicate so in response to the status inquiry at 510, or provide no response. If, at 504, the non-destination client is ready to participate, it may indicate at 506 its readiness in response to the status inquiry. At 508, the client may download a content segment from the CDN via a specified transmission path. At 510, the client may relay the downloaded content segment to a designated node for assembly.

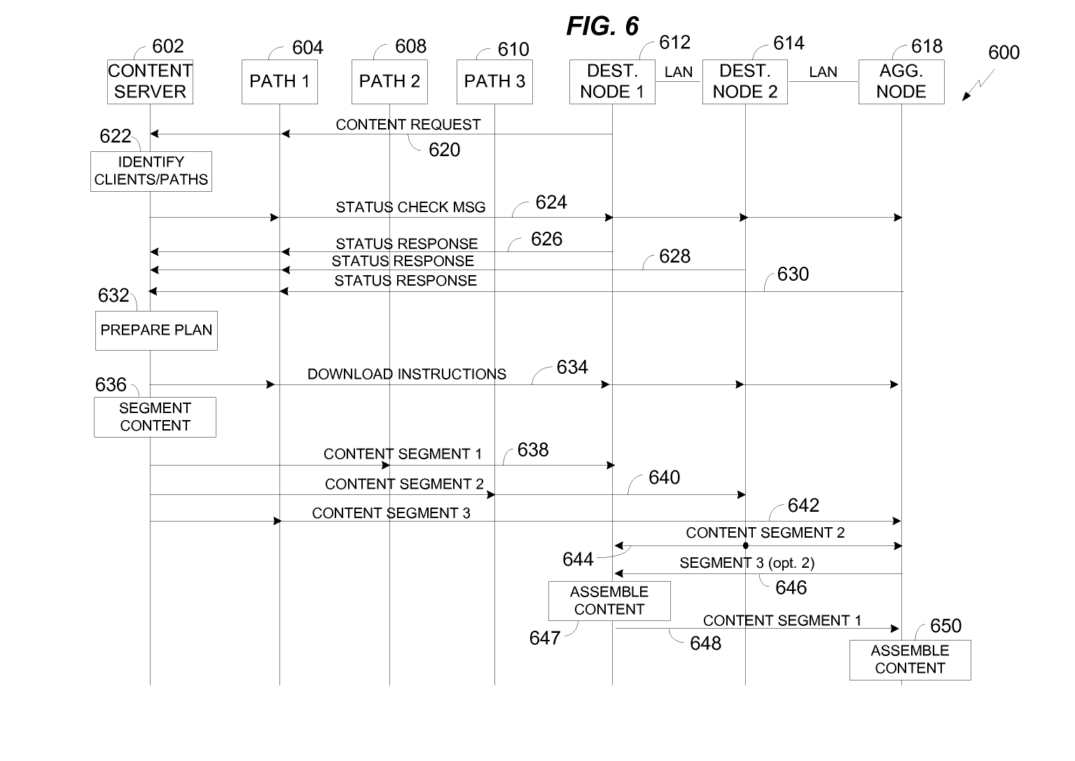

FIG. 6 is a sequence diagram illustrating an example of data flows and operations 600 involving different nodes and networks, for content delivery using diversified networks to deliver data files. FIG. 6 provides an overview of the operations discussed individually for the client components above. The call flows may involve a content server 602, multiple transmission paths 604, 608 and 610, a first destination node 612 for the content, a second destination node 614 and an aggregation node 618. Nodes 612, 614 and 618 may be coupled by a LAN or similar network. The first path 604 may represent a broadband connection via a router and modem to a WAN and thence to the content server 602. The second a third paths 608, 610 may represent WCNs operated by different operators (or by the same operator) using different spectrum, typically communicating with the client node via wireless base stations.

The first destination node 612 may transmit 620 a content request message via the first transmission path 604 to the content server 602. In response, the content server may identify 622 suitable clients and possible transmission paths 604, 608, 610. At 624, the content server may transmit a status request message to the first node 612, second node 614 and aggregation node 618. At 626, the first node responds; concurrently the second node responds 628 and also, at 630, the aggregation node. From the responses, the content server 602 prepares a downloading plan 632, also called downloading instructions, for the requested content. At 634, the content server provides the plans/instructions to the participating client nodes 612, 614 and 618. Although shown as a single message, these may include separate messages to individual nodes. At 636, the content server may prepare content segments for download.

At 638, the content server may provide a first content segment via a selected second transmission path 608 to the first destination node 612. Concurrently at 640, the content server may provide a second content segment via a selected third transmission path 610 to the second destination node 614. Concurrently at 642, the content server may provide a third content segment via a selected first transmission path 610 to the aggregation node 618. At 644, the second destination node may provide the second segment to the first node 612, to the aggregation node 618, or to both 612 and 618, using the LAN. Optionally, at 646, the aggregation node may provide the third segment to the first node 644, using the LAN. Optionally at 647, the first node 612 may assemble the content from the three segments, for use as desired at the first node 612. At 648, the first node may provide the first content segment to the aggregation node 618. At 650, the aggregation node may assemble the content and store it for future use. The aggregation node may, if the requesting node 612 has not already assembled the content itself, transmit the assembled content to the requesting node 612 via the LAN.

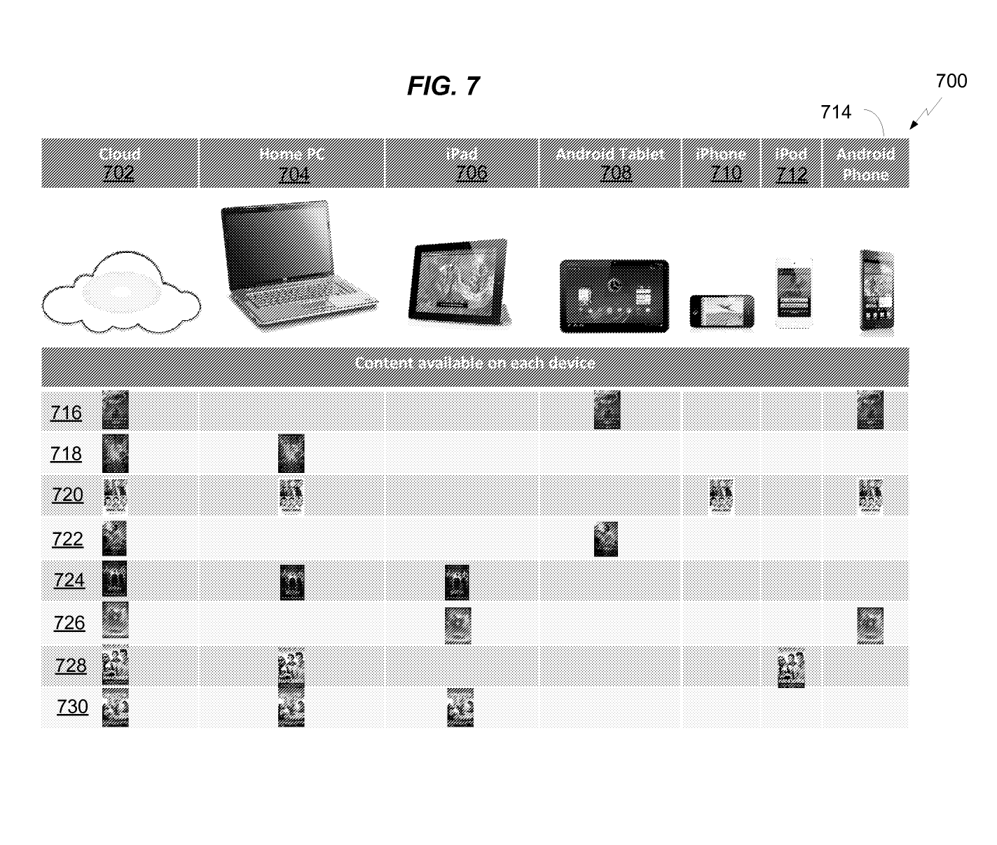

FIG. 7 is a screen shot showing an example of a data table or “dashboard” 700 that a member of a subscriber group may use to access or organize content that is deemed accessible within the group. The dashboard 700 may be displayed using a user interface; the exact organization or appearance of the dashboard is not a limiting feature of the technology. Instead, the tables 700 illustrates how a content server system may organize and track content belonging to a user, shown in rows 716-730, which may be stored and available on different devices in a group represented by the columns 704-712, and also in a cloud server 702.

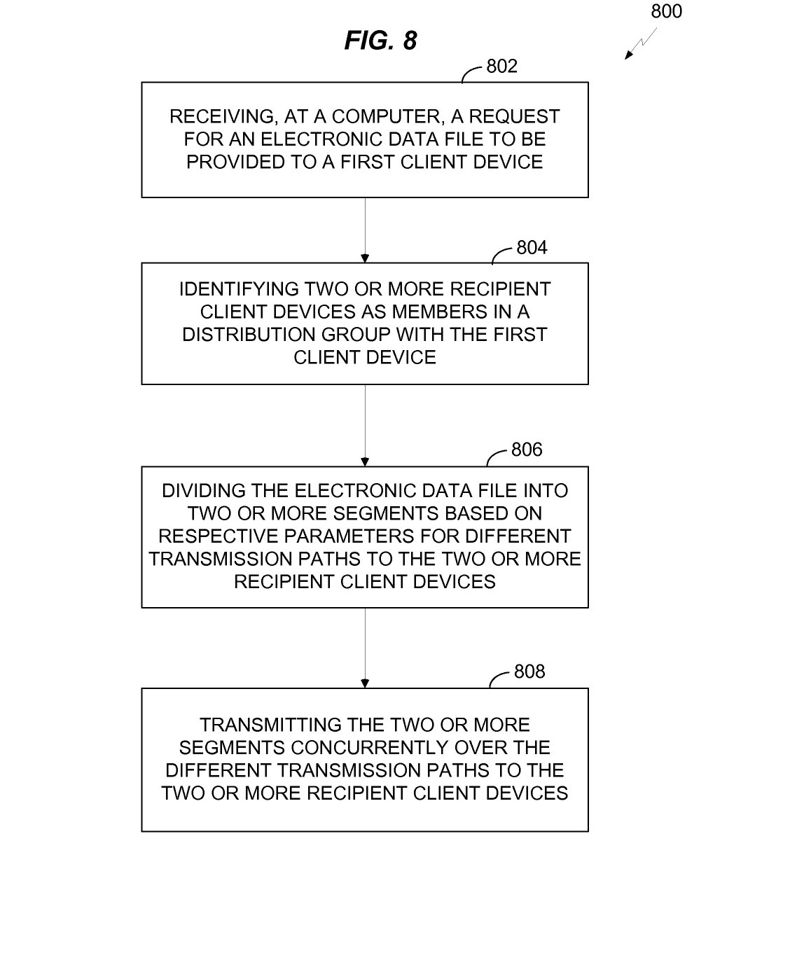

Another example of a method for content delivery using diversified networks to deliver data files, for performance by a content distribution node, is shown in FIG. 8. Complementary or related aspects of the method 200 discussed above are shown in a more summary fashion in FIG. 8. The methods 200 and 800 should not be regarded as distinct methods, but as different, complementary descriptions of the same or closely related methods.

The method 800 may include, at 802, receiving, at a computer, a request for an electronic data file to be provided to a first client device. The method 800 may further include, at 804, identifying two or more recipient client devices as members in a distribution group with the first client device. The method 800 may include, at 806, dividing the electronic data file into two or more segments based on respective parameters for different transmission paths to the two or more recipient client devices. The method 800 may include, at 808, transmitting the two or more segments concurrently over the different transmission paths to the two or more recipient client devices.

In further aspects, the method 800 may include generating instructions for assembling the two or more segments to obtain the electronic data file. In such case, the method 800 may include transmitting the instructions to at least one of the first client device or the two or more recipient client devices.

In addition, the method 800 may include determining a current status of members of the distribution group, in response to receiving the request for the electronic data file. In an aspect, identifying the two or more recipient client devices may include selecting the two or more recipient devices based on the current status. In another aspect, selecting the two or more recipient devices may be further based on the respective parameters of the different transmissions paths. These respective parameters may be selected, for example, from a maximum data rate, a bandwidth, and a signal quality.

In another aspect, the method 800 may include receiving confirmation messages from each of the two or more recipient devices, confirming that each segment has been received. Identifying the two or more recipient client devices may include selecting the two or more recipient client devices to include the first client device. In the alternative, identifying the two or more recipient client devices may include selecting the two or more recipient client devices to exclude the first client device. The different transmission paths may include different communication networks. The method 800 may further include determining the distribution group by membership in a LAN.

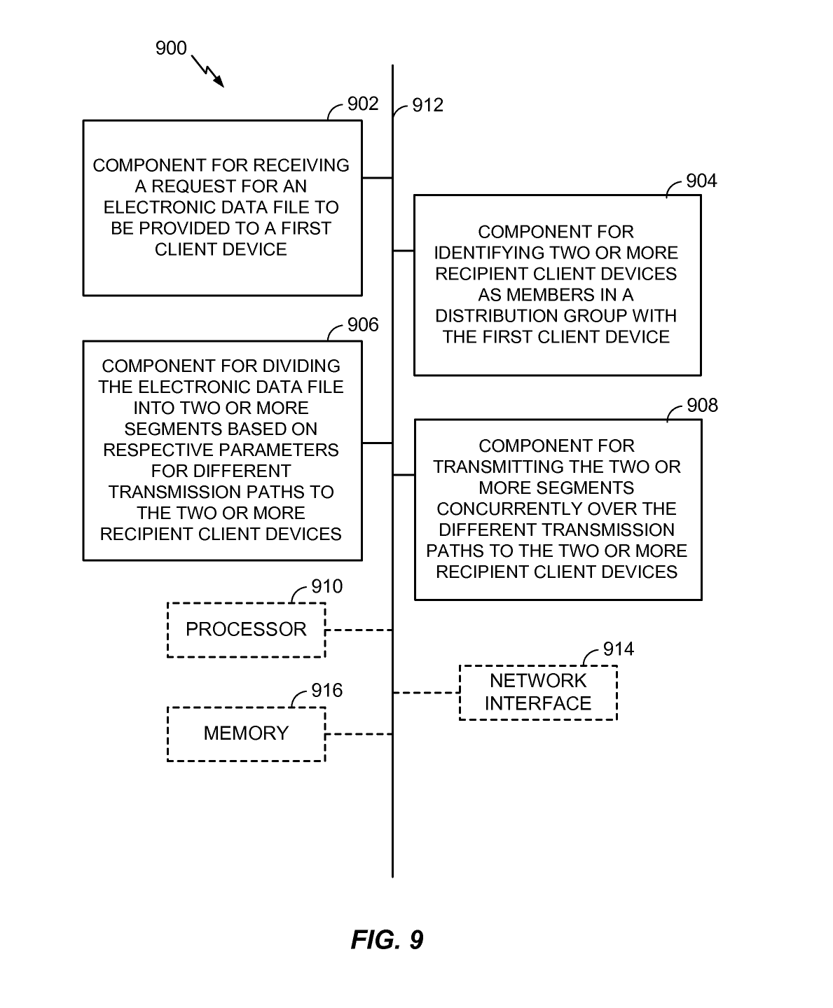

Consistent with method 800, and as further illustrated by FIG. 9, an apparatus 900 may function as content server. The apparatus 900 may comprise an electronic component or module 902 for receiving a request for an electronic data file to be provided to a first client device. The apparatus 900 may comprise an electronic component or module 904 for identifying two or more recipient client devices as members in a distribution group with the first client device. In addition, the apparatus 900 may comprise an electronic component or module 906 for dividing the electronic data file into two or more segments based on respective parameters for different transmission paths to the two or more recipient client devices. The apparatus 900 may comprise an electronic component or module 908 for transmitting the two or more segments concurrently over the different transmission paths to the two or more recipient client devices.

The apparatus 900 may optionally include a processor module 910 having at least one processor; in the case of the apparatus 900 this may be configured as a computer server, rather than as a general purpose microprocessor. The processor 910, in such case, may be in operative communication with the modules 902-908 via a bus 912 or similar communication coupling. The processor 910 may effect initiation and scheduling of the processes or functions performed by electrical components 902-908, and other operations described in connection with methods 200 and 800.

In related aspects, the apparatus 900 may include a network interface module 914 through with the processor 910 may send and receive information to clients and other servers. In further related aspects, the apparatus 900 may optionally include a module for storing information, such as, for example, a memory device/module 916. The computer readable medium or the memory module 916 may be operatively coupled to the other components of the apparatus 900 via the bus 912 or the like. The memory module 916 may be adapted to store computer readable instructions and data for effecting the processes and behavior of the modules 902-908, and subcomponents thereof, or the processor 910, or the methods disclosed herein, and other operations for content distribution using diverse networks as disclosed herein. The memory module 916 may retain instructions for executing functions associated with the modules 902-908. While shown as being external to the memory 916, it is to be understood that the modules 902-908 may exist at least partly within the memory 916.

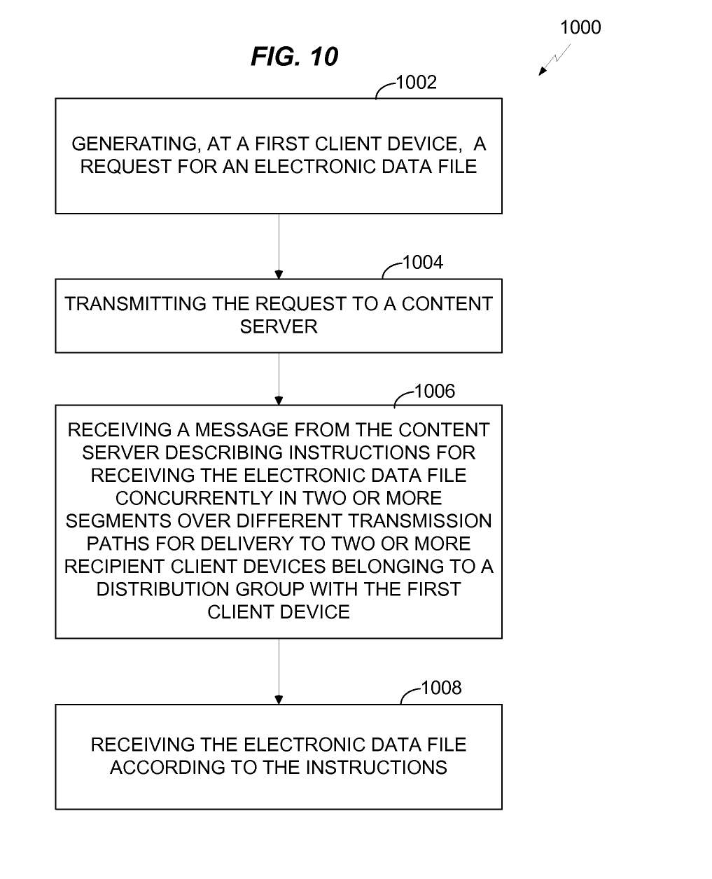

FIG. 10 is a flow chart illustrating another example of a method for content delivery using diversified networks to deliver data files, for performance by a requesting content destination node. Complementary or related aspects of the method 300 discussed above are shown in a more summary fashion in FIG. 10. The methods 300 and 1000 should not be regarded as distinct methods, but as different, complementary descriptions of the same or closely related methods.

The method 1000 may include, at 1002, generating, at a first client device, a request for an electronic data file. The method 1000 may include, at 1004, transmitting the request to a content server. The method 1000 may include, at 1006 receiving a message from the content server describing instructions for receiving the electronic data file concurrently in two or more segments over different transmission paths for delivery to two or more recipient client devices belonging to a distribution group with the first client device. The method 1000 may include, at 1008, receiving the electronic data file according to the instructions.

In further aspects, the method 1000 may include assembling the two or more segments to obtain the electronic data file. The method may include receiving at least one of the two or more segments via one of the different transmission paths, and providing the at least one of the two or more segments to a designated node in the distribution group. In an aspect, receiving the electronic data file may include receiving the electronic data file from the designated node. The method may include receiving the electronic data file via a LAN. In an aspect, the first client device does not receive any of the two or more segments until said segments are assembled into the electronic data file.

In another aspect, the method 1000 may include providing a parameter of one of the different transmissions paths to the content server, in response to a status inquiry. Providing the parameter may include, for example, selecting a parameter from a maximum data rate, a bandwidth, and a signal quality.

The method 1000 may include identifying one or more members of the distribution group to the content server. The identifying may include identifying a network address for a LAN to which the two or more recipient client devices are connected.

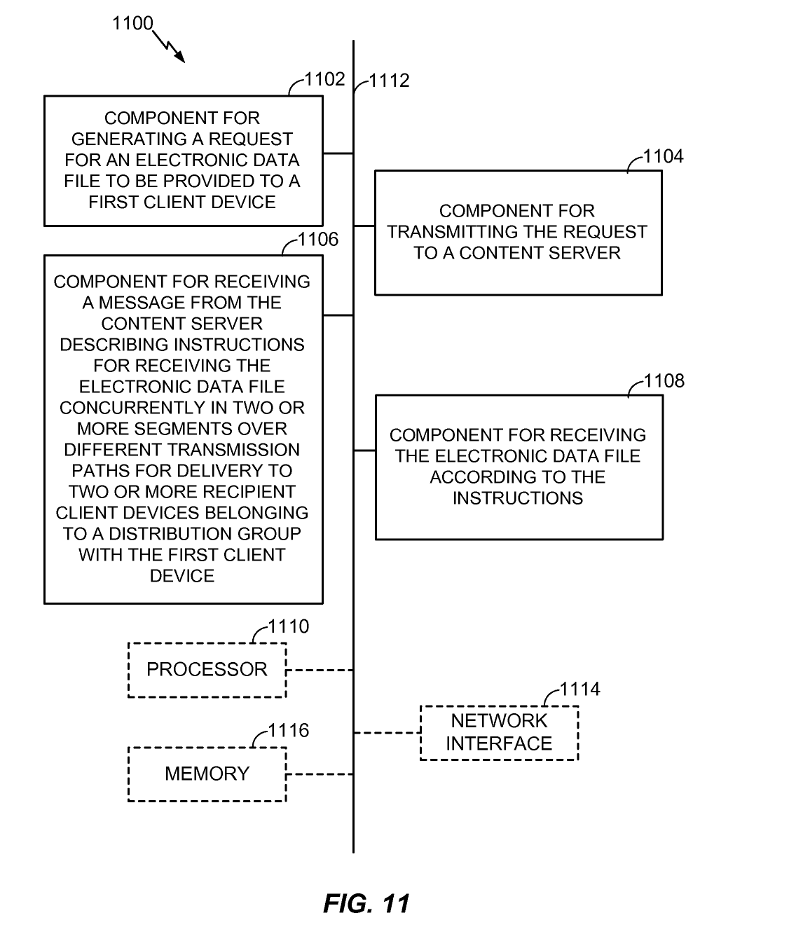

Consistent with method 1000, and as further illustrated by FIG. 11, an apparatus 1100 may function as client node. The apparatus 1100 may comprise an electronic component or module 1102 for generating, at a first client device, a request for an electronic data file. The apparatus 1100 may comprise an electronic component or module 1104 for transmitting the request to a content server. In addition, the apparatus 1100 may comprise an electronic component or module 1106 for receiving a message from the content server describing instructions for receiving the electronic data file concurrently in two or more segments over different transmission paths for delivery to two or more recipient client devices belonging to a distribution group with the first client device. The apparatus 1100 may comprise an electronic component or module 1108 for receiving the electronic data file according to the instructions.

The apparatus 1100 may optionally include a processor module 1110 having at least one processor; in the case of the apparatus 1100 this may be configured as a computer server, rather than as a general purpose microprocessor. The processor 1110, in such case, may be in operative communication with the modules 1102-1108 via a bus 1112 or similar communication coupling. The processor 1110 may effect initiation and scheduling of the processes or functions performed by electrical components 1102-1108, or other operations of the methods 300 or 1000.

In related aspects, the apparatus 1100 may include a network interface module 1114 through with the processor 1110 may send and receive information to clients and other servers. In further related aspects, the apparatus 1100 may optionally include a module for storing information, such as, for example, a memory device/module 1116. The computer readable medium or the memory module 1116 may be operatively coupled to the other components of the apparatus 1100 via the bus 1112 or the like. The memory module 1116 may be adapted to store computer readable instructions and data for effecting the processes and behavior of the modules 1102-1108, and subcomponents thereof, or the processor 1110, or the methods disclosed herein, and other operations for distributing content using diverse networks. The memory module 1116 may retain instructions for executing functions associated with the modules 1102-1108. While shown as being external to the memory 1116, it is to be understood that the modules 1102-1108 may exist at least partly within the memory 1116.

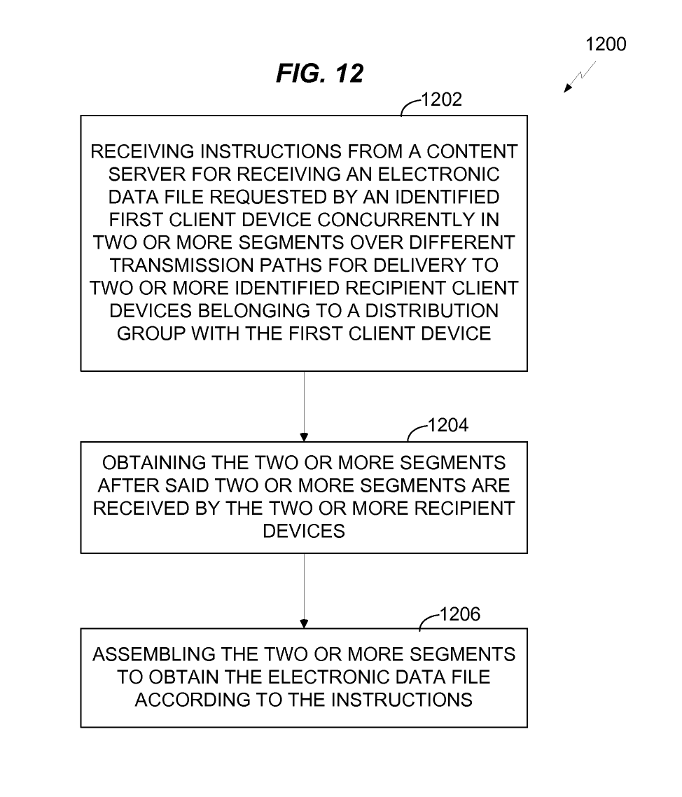

FIG. 12 is a flow chart illustrating another example of a method for content delivery using diversified networks to deliver data files, for performance by a non-requesting content destination node. Complementary or related aspects of the method 400 discussed above are shown in a more summary fashion in FIG. 12. The methods 400 and 1200 should not be regarded as distinct methods, but as different, complementary descriptions of the same or closely related methods.

The method 1200 may include, at 1202, receiving instructions from a content server for receiving an electronic data file requested by an identified first client device concurrently in two or more segments over different transmission paths for delivery to two or more identified recipient client devices belonging to a distribution group with the first client device. The method 1200 may include, at 1204, obtaining the two or more segments after said two or more segments are received by the two or more recipient devices. The method 1200 may include, at 1206, assembling the two or more segments to obtain the electronic data file according to the instructions.

In further aspects, the method 1200 may include transmitting the electronic data file to the first client device. The transmitting may be performed over a LAN. The method 1200 may further include receiving at least one of the two or more segments. The method 100 may further include providing the at least one of the two or more segments to the first client before assembling the two or more segments. The method 100 may further include receiving the at least one of the two or more segments from the content server. In the alternative, or in addition, the method may include receiving the at least one of the two or more segments from at least one of the two or more recipient client devices. The method 1200 may further include storing the electronic data file for later distribution to a member of the distribution group.

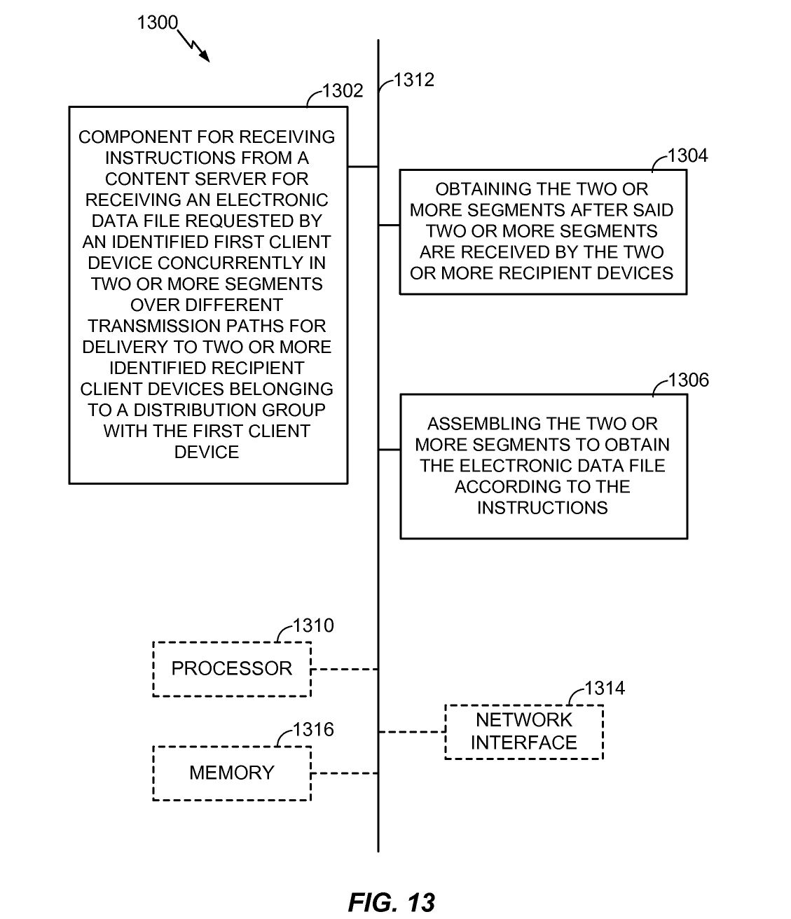

Consistent with method 1200, and as further illustrated by FIG. 13, an apparatus 1300 may function as client node. The apparatus 1300 may comprise an electronic component or module 1302 for receiving instructions from a content server for receiving an electronic data file requested by an identified first client device concurrently in two or more segments over different transmission paths for delivery to two or more identified recipient client devices belonging to a distribution group with the first client device. The apparatus 1300 may comprise an electronic component or module 1304 for obtaining the two or more segments after said two or more segments are received by the two or more recipient devices. In addition, the apparatus 1300 may comprise an electronic component or module 1306 for assembling the two or more segments to obtain the electronic data file according to the instructions.

The apparatus 1300 may optionally include a processor module 1310 having at least one processor; in the case of the apparatus 1300 this may be configured as a computer server, rather than as a general purpose microprocessor. The processor 1310, in such case, may be in operative communication with the modules 1302-1306 via a bus 1312 or similar communication coupling. The processor 1310 may effect initiation and scheduling of the processes or functions performed by electrical components 1302-1306.

In related aspects, the apparatus 1300 may include a network interface module 1314 through with the processor 1310 may send and receive information to clients and other servers. In further related aspects, the apparatus 1300 may optionally include a module for storing information, such as, for example, a memory device/module 1316. The computer readable medium or the memory module 1316 may be operatively coupled to the other components of the apparatus 1300 via the bus 1312 or the like. The memory module 1316 may be adapted to store computer readable instructions and data for effecting the processes and behavior of the modules 1302-1306, and subcomponents thereof, or the processor 1310, or the methods disclosed herein, and other operations for content identification, playing, copying, and other use. The memory module 1316 may retain instructions for executing functions associated with the modules 1302-1308. While shown as being external to the memory 1316, it is to be understood that the modules 1302-1306 may exist at least partly within the memory 1316.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer-readable media may include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or non-transitory medium.

1. A method, comprising:
receiving, at a computer, a request for an electronic data file to be provided to a first client device;
identifying two or more recipient client devices as members in a distribution group with the first client device;
dividing the electronic data file into two or more segments based on respective parameters for different transmission paths to the two or more recipient client devices; and
transmitting the two or more segments concurrently over the different transmission paths to the two or more recipient client devices.

2. The method of claim 1, further comprising generating instructions for assembling the two or more segments to obtain the electronic data file, and transmitting the instructions to at least one of the first client device or the two or more recipient client devices.

3. The method of claim 1, further comprising determining a current status of members of the distribution group, in response to receiving the request for the electronic data file.

4. The method of claim 1, wherein the identifying the two or more recipient client devices comprises selecting the two or more recipient devices based on the current status.

5. The method of claim 4, wherein selecting the two or more recipient devices is further based on respective parameters of the different transmissions paths, wherein the respective parameters are selected from a maximum data rate, a bandwidth, and a signal quality.

6. The method of claim 1, wherein the identifying the two or more recipient client devices comprises excluding the first client device.

7. The method of claim 1, wherein the different transmission paths comprise different communication networks.

8. The method of claim 1, further comprising determining the distribution group by membership in a Local Area Network.

9. An apparatus comprising a processor coupled to a memory, the memory holding instructions for:
receiving a request for an electronic data file to be provided to a first client device;
identifying two or more recipient client devices as members in a distribution group with the first client device;
dividing the electronic data file into two or more segments based on respective parameters for different transmission paths to the two or more recipient client devices; and
transmitting the two or more segments concurrently over the different transmission paths to the two or more recipient client devices.

10. A method, comprising:
generating, at a first client device, a request for an electronic data file;
transmitting the request to a content server;
receiving a message from the content server describing instructions for receiving the electronic data file concurrently in two or more segments over different transmission paths for delivery to two or more recipient client devices belonging to a distribution group with the first client device; and
receiving the electronic data file according to the instructions.

11. The method of claim 10, further comprising assembling the two or more segments to obtain the electronic data file.

12. The method of claim 10, further comprising receiving at least one of the two or more segments via one of the different transmission paths, and providing the at least one of the two or more segments to a designated node in the distribution group.

13. The method of claim 12, wherein receiving the electronic data file comprises receiving the electronic data file from the designated node.

14. The method of claim 10, wherein the first client device does not receive any of the two or more segments until said segments are assembled into the electronic data file.

15. The method of claim 10, further comprising identifying one or more members of the distribution group to the content server.

16. The method of claim 15 wherein identifying comprises identifying a network address for a Local Area Network to which the two or more recipient client devices are connected.

17. An apparatus comprising a processor coupled to a memory, the memory holding instructions for:
generating a request for an electronic data file to be provided to a first client device;
transmitting the request to a content server;
receiving a message from the content server describing instructions for receiving the electronic data file concurrently in two or more segments over different transmission paths for delivery to two or more recipient client devices belonging to a distribution group with the first client device; and
receiving the electronic data file according to the instructions.

18. A method, comprising:
receiving instructions from a content server for receiving an electronic data file requested by an identified first client device concurrently in two or more segments over different transmission paths for delivery to two or more identified recipient client devices belonging to a distribution group with the first client device;
obtaining the two or more segments after said two or more segments are received by the two or more recipient devices; and
assembling the two or more segments to obtain the electronic data file according to the instructions.

19. The method of claim 18, further comprising transmitting the electronic data file to the first client device.

20. The method of claim 18, further comprising receiving at least one of the two or more segments from at least one of the content server or the two or more recipient client devices.

21. The method of claim 20, further comprising providing the at least one of the two or more segments to the first client before assembling the two or more segments.

22. The method of claim 18, further comprising storing the electronic data file for later distribution to a member of the distribution group.

23. An apparatus comprising a processor coupled to a memory, the memory holding instructions for:
receiving instructions from a content server for receiving an electronic data file requested by an identified first client device concurrently in two or more segments over different transmission paths for delivery to two or more identified recipient client devices belonging to a distribution group with the first client device;
obtaining the two or more segments after said two or more segments are received by the two or more recipient devices; and
assembling the two or more segments to obtain the electronic data file according to the instructions.
